(19) United States
(12) Patent Application Publication
(10) Pub. No.: US 2008/0214223 A1
(43) Pub. Date: Sep. 4, 2008

(54) Push-to-talk pressing device

(75) Inventor: Nir Klein, Rishpon (IL)

Correspondence Address: Active Knowledge Ltd., POB 294, Kiryat Tivon, 36010, IL

(73) Assignee: Source Of Sound Ltd.

(21) Appl. No.: 11/656,372

(22) Filed: Jan. 23, 2007

(51) Int. Cl. H04B 7/00; H04Q 7/20

(52) U.S. Cl. 455/518

(57) ABSTRACT

A PTT pressing device for pressing a PTT switch in a continuous manner. The PTT pressing device comprises a PTT pressing element, whereby the PTT pressing element presses the PTT switch to its pressed state, and a mounting element, whereby the mounting element is mounting the PTT pressing element over the PTT switch in a stable manner. The PTT pressing element and the mounting element may be a single element.

### FIELD OF THE INVENTION

The present invention relates to PTT pressing devices, and, more particularly, to PTT pressing devices for pressing PTT switches in a continuous manner.

### BACKGROUND

In communication systems such as telephone systems or two-way radio systems having a Press-To-Talk (PTT) feature, also known as Press-To-Transmit or Push-To-Talk or Push-To-Transmit, the speaker is required to operate a switch while talking, i.e. the PTT switch allows the speaker to be heard only when the switch is activated. The PTT feature is useful, for example, when the same frequency is employed by both transmitters, when operating in noisy environments, for privacy, for military applications, and in other cases.

Basic principles and details relating to PTT devices needed for properly understanding the present invention are readily available in standard references in the fields of communication systems.

### BRIEF DESCRIPTION OF THE DRAWINGS

The present invention is herein described, by way of example only, with reference to the accompanying drawings. With specific reference now to the drawings, it is stressed that the particulars shown are by way of example and for purposes of illustrative discussion of the embodiments of the present invention only, and are presented in order to provide what is believed to be the most useful and readily understood description of the principles and conceptual aspects of the present invention. In this regard, no attempt is made to show structural details of the present invention in more detail than is necessary for a fundamental understanding of the invention, the description taken with the drawings making apparent to those skilled in the art how the several forms of the invention may be embodied in practice. Identical structures, elements or parts which appear in more than one figure are preferably labeled with a same or similar number in all the figures in which they appear. In the drawings:

FIG. 1 is an illustration of a PTT pressing device, in accordance with the present invention;

FIG. 2 is an illustration of a prior art PTT device;

FIG. 3 is an illustration of a PTT pressing device mounted over a PTT switch, in accordance with the present invention;

FIG. 4 is an exploded view of a PTT pressing device and a PTT switch, in accordance with the present invention;

FIG. 5 is an illustration of a PTT pressing device, in accordance with the present invention;

FIG. 6 is an illustration of a prior art PTT device;

FIG. 7 is an illustration of a PTT pressing device mounted over a PTT switch, in accordance with the present invention; and

FIG. 8 is an exploded view of a PTT pressing device and a PTT switch, in accordance with the present invention.

### DETAILED DESCRIPTION

The present invention relates to PTT pressing devices. It is to be understood that the present invention is not limited in its application by the details of the implementation of the devices and/or the details of construction, arrangement, and composition of the components of the devices set forth in the following description, drawings or examples. While specific steps, configurations and arrangements are discussed, it is to be understood that this is done for illustrative purposes only. A person skilled in the relevant art will recognize that other steps, embodiments, configurations and arrangements can be used without departing from the spirit and scope of the present invention.

The present invention is capable of other embodiments and of being practiced or carried out in various ways. Also, it is to be understood that the phraseology, terminology and notation employed herein are for the purpose of description and should not be regarded as limiting.

In the following description of the devices of the present invention, included are only main or principal steps needed for sufficiently understanding proper ‘enabling’ utilization and implementation of the disclosed PTT pressing devices.

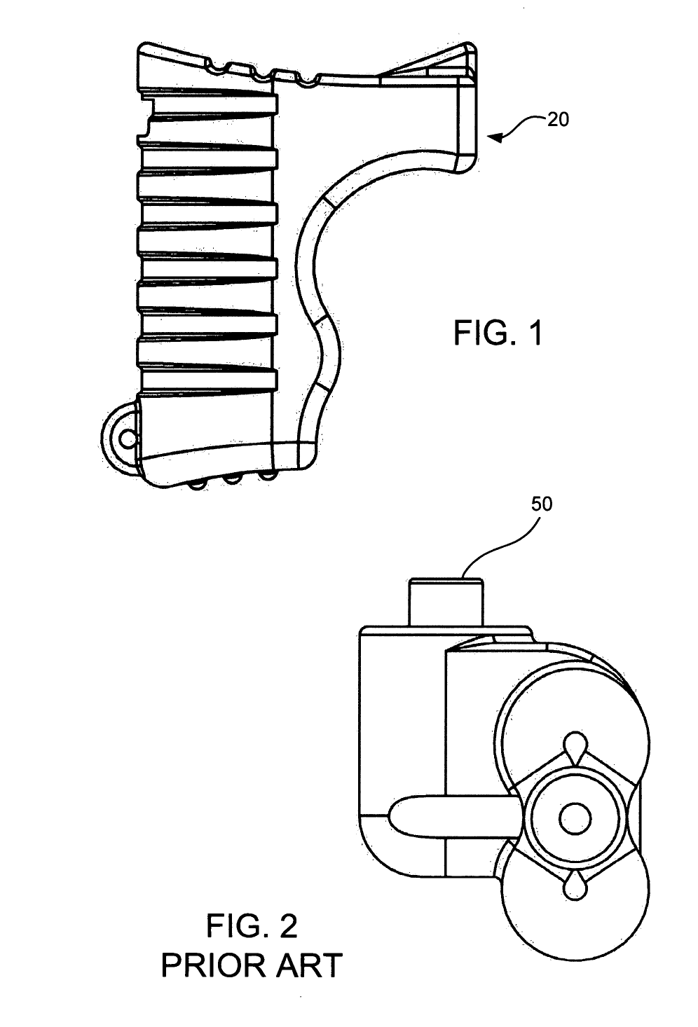

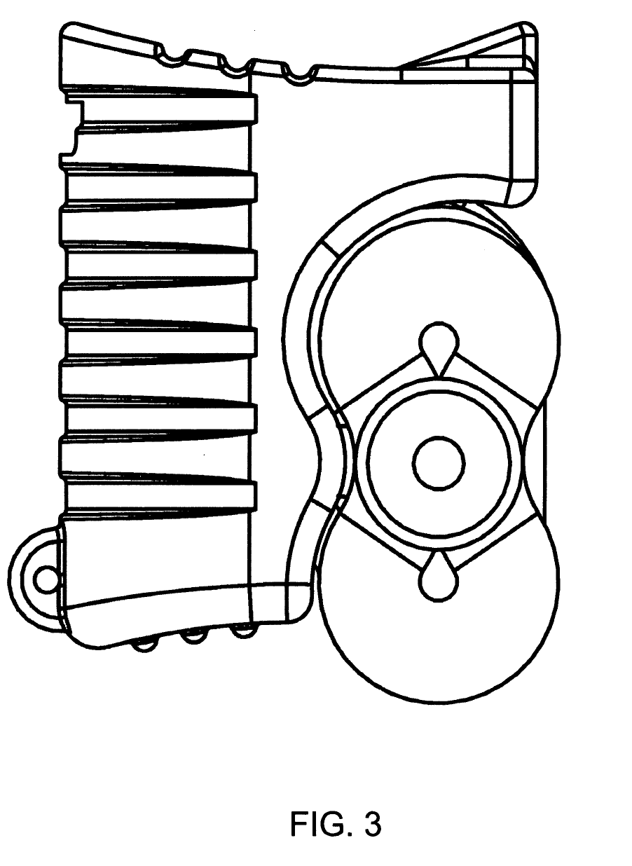

FIG. 1 illustrates a PTT pressing device 20 used for pressing a momentary PTT switch 50, as illustrated in FIG. 2, to its pressed state, in a continuous manner.

In one embodiment, the PTT pressing device 20 includes a PTT pressing element used for pressing the PTT switch to its pressed state, and a mounting element used for mounting the PTT pressing element over the PTT switch in a stable manner.

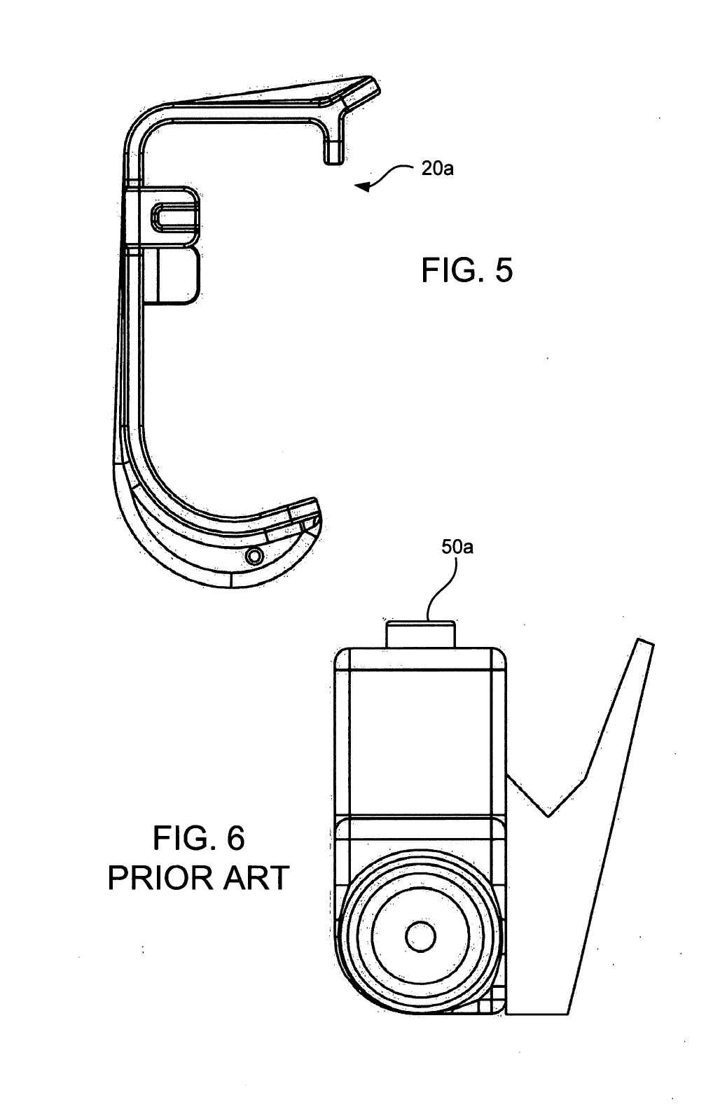

FIG. 1 and FIG. 5 illustrate two embodiments of a PTT pressing device (20 and 20a), made as a single element, in accordance with the embodiments of the present invention.

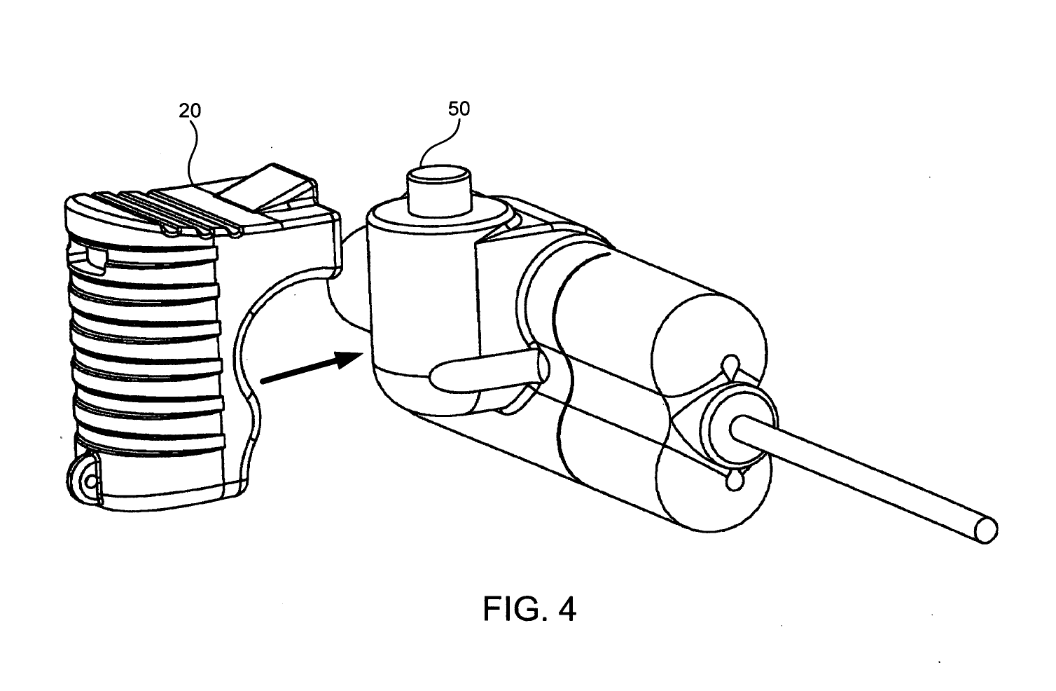

PTT pressing device 20 is mounted over PTT switch 50, as illustrated in FIG. 3 and FIG. 4.

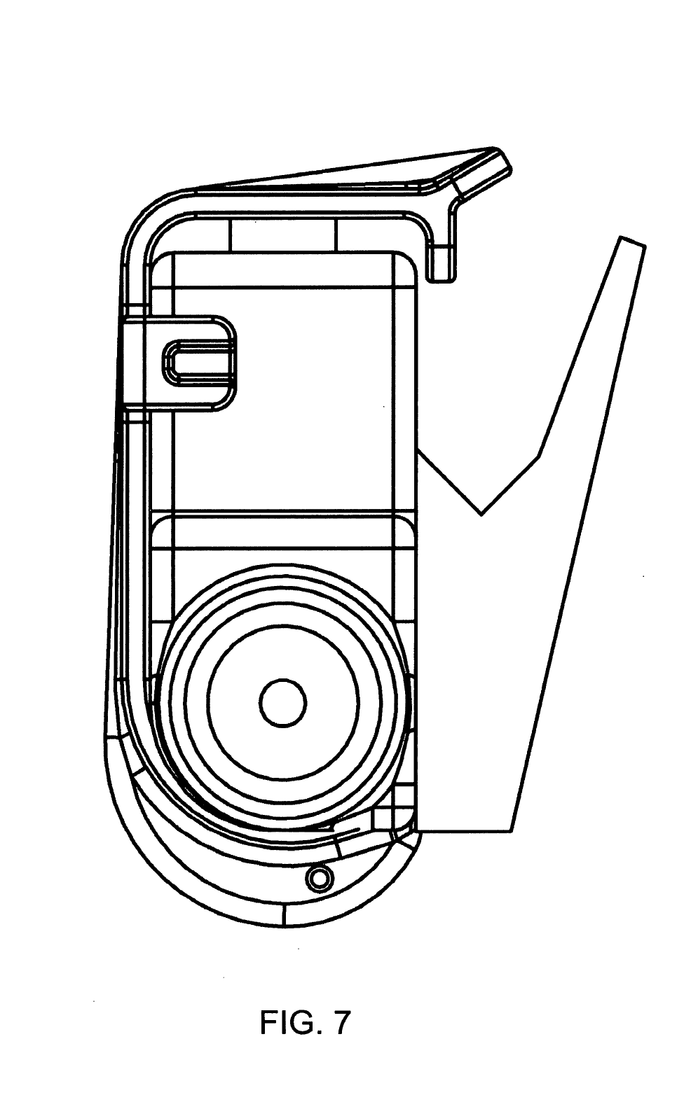

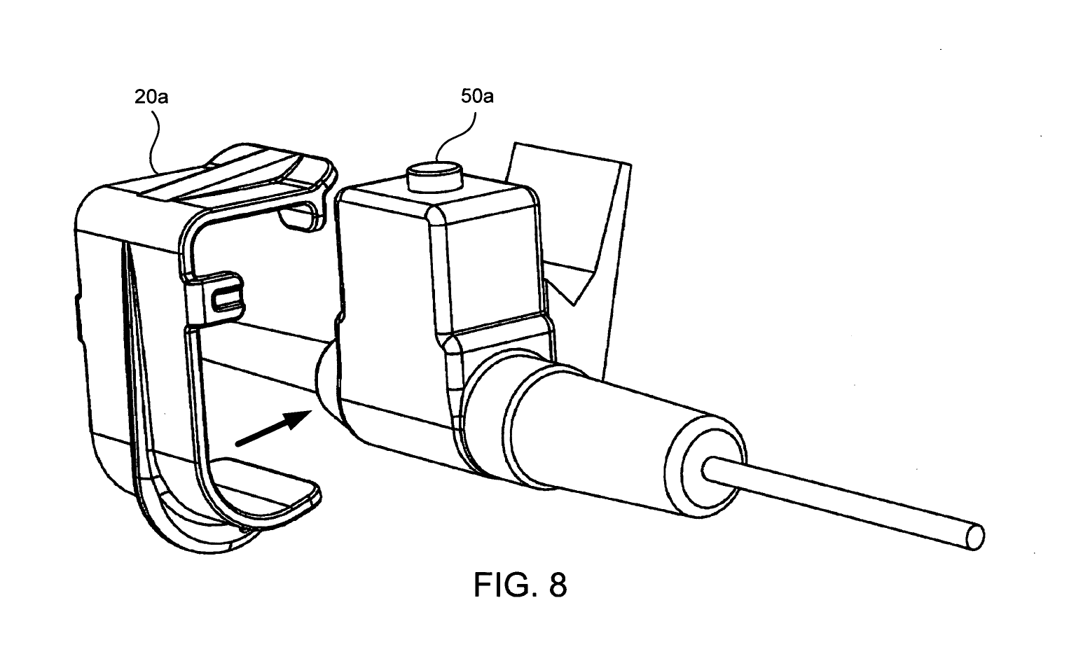

PTT pressing device 20a illustrated in FIG. 5 fits the prior art PTT device illustrated in FIG. 6. PTT pressing device 20a is mounted over PTT switch 50a, as illustrated in FIG. 7 and FIG. 8.

In one embodiment, PTT pressing device 20 may feature quick disconnect. Optionally, a user of the quick disconnect PTT pressing device is able to disconnect the quick disconnect PTT pressing device using one hand.

In one embodiment, the PTT pressing device may be mounted over the PTT switch from a PTT switch facet direction, in order to enable a quick disconnect. Optionally, the PTT pressing device may feature such a stable mounting over the PTT switch that when used in or on an air vehicle, a ground vehicle and/or a water vehicle, the switch will not be released by movement of the vehicle.

In one embodiment, the PTT pressing device does not feature a quick disconnect. Optionally, a user of a PTT pressing device, which does not feature a quick disconnect, has to use both hands in order to disconnect the PTT pressing device.

Examples of PTTs which do not feature a quick disconnect are:

a) PTT pressing devices which require both hands for releasing the PTT pressing device.

b) PTT pressing devices which require a tool, such as a key, stick or lever, for releasing the PTT pressing device.

In one embodiment (not shown in the figures), the PTT device may comprise a first PTT switch and a second PTT switch. And the PTT pressing device covers the first PTT switch but does not cover the second PTT switch when pressing the first PTT switch.

In one embodiment (not shown in the figures), the PTT device may comprise a PTT switch and a PTT interface connection. And the PTT pressing device covers the PTT switch but does not cover the PTT interface connection when pressing the PTT switch.

In one embodiment, a wireless PTT may be linked to the PTT switch 50 and the PTT pressing device may cover all of the PTT switch.

In one embodiment, the PTT pressing device may be made of a polymer. The polymer may be a polyvinyl chloride, such as plastic, or any other equivalent. It is to be understood that the PTT pressing device may be made of any known in the art material which satisfies the requirements of the embodiments of the present invention.

In one embodiment, the PTT pressing device may be made of a polymer that is flexible and deformable enough to be mounted over a PTT switch and to press the PTT switch to its pressed state, and is elastic enough to enable a fast release of the PTT switch, when needed.

In one embodiment, the PTT pressing device may feature a shape that leads or guides the user in mounting the PTT pressing device over the PTT switch in a correct manner. For example, the PTT pressing device may be asymmetric, may include one or more tracks or grooves, or may enable a user to mount the PTT pressing device over a PTT switch from more than one direction.

In one embodiment, the PTT pressing device may be a foldable PTT pressing device. Optionally, the foldable PTT pressing device includes at least one pivot and/or at least one elastic element.

It is appreciated that certain features of the invention, which are, for clarity, described in the context of separate embodiments, may also be provided in various combinations in a single embodiment. Conversely, various features of the invention, which are, for brevity, described in the context of a single embodiment, may also be provided separately or in any suitable sub-combination.

It is to be understood that the present invention is not limited in its application to the details of the operation or implementation of the devices set in the description, drawings, or examples of the present invention.

While the invention has been described in conjunction with specific embodiments and examples thereof, it is to be understood that they have been presented by way of example, and not limitation. Moreover, it is evident that many alternatives, modifications and variations will be apparent to those skilled in the art. Accordingly, it is intended to embrace all such alternatives, modifications and variations that fall within the spirit and scope of the appended claims and their equivalents.

What is claimed is:

1. A PTT pressing device for pressing a PTT switch in a continuous manner, comprising:
a PTT pressing element, whereby the PTT pressing element presses the PTT switch to its pressed state, and
a mounting element, whereby the mounting element is mounting the PTT pressing element over the PTT switch in a stable manner.

2. The PTT pressing device of claim 1, wherein the PTT pressing element and the mounting element are a single element.

3. The PTT pressing device of claim 1, wherein the PTT pressing device features a quick disconnect.

4. The PTT pressing device of claim 3, wherein a user of the PTT pressing device is able to disconnect the PTT pressing device using one hand.

5. The PTT pressing device of claim 1, wherein a user of the PTT pressing device has to use both hands in order to disconnect the PTT pressing device.

6. The PTT pressing device of claim 1, wherein the PTT switch further comprises a second PTT switch, and the PTT pressing device covers the PTT switch but does not cover the second PTT switch.

7. The PTT pressing device of claim 1, wherein the PTT switch further comprises a PTT interface connection and the PTT pressing device covers the PTT switch but does not cover the PTT interface connection.

8. The PTT pressing device of claim 1, wherein a wireless PTT is linked to the PTT switch and the PTT pressing device covers all of the PTT switch.

9. The PTT pressing device of claim 1, wherein the PTT pressing device is made of a polymer.

10. The PTT pressing device of claim 1, wherein the PTT pressing device features a shape, which leads the user while placing the PTT pressing device over the PTT switch.

11. The PTT pressing device of claim 1, wherein the PTT pressing device is foldable.

12. The foldable PTT pressing device of claim 11, wherein the foldable PTT pressing device comprises at least one pivot.

13. The foldable PTT pressing device of claim 11, wherein the foldable PTT pressing device comprises at least one elastic element.

14. The foldable PTT pressing device of claim 11, wherein the foldable PTT pressing device comprises at least one pivot and at least one elastic element.
